(19) United States
(12) Patent Application Publication
(10) Pub. No.: US 2026/0235984 A1
(43) Pub. Date: Aug. 13, 2026

(54) PRINTING SYSTEM INCLUDING CHARGE REMOVAL APPARATUS, CONTROL METHOD, AND STORAGE MEDIUM

(71) Applicant: CANON KABUSHIKI KAISHA, Tokyo (JP)

(72) Inventor: HIDEYUKI OKADA, Ibaraki (JP)

(21) Appl. No.: 19/450,169

(22) Filed: Jan. 15, 2026

(30) Foreign Application Priority Data
Feb. 12, 2025 (JP) 2025-020586

(51) Int. Cl. G03G 15/00; G03G 15/23

(52) U.S. Cl. CPC G03G 15/6573; G03G 15/234; G03G 15/502; G03G 15/5029; G03G 2215/00767

(57) ABSTRACT

A printing system including a charge removal apparatus, the printing system includes a printer unit configured to print an image on a sheet, a measurement unit configured to measure an amount of charge on the sheet with the image printed thereon by the printer unit, a processor configured to calculate a charge removal setting value for charge removal using the charge removal apparatus based on the amount of charge measured by the measurement unit, and a storage device configured to store the charge removal setting value as information about the sheet.

### BACKGROUND

### Field of the Technology

The present disclosure relates to a printing system including a charge removal apparatus, a control method for the printing system, and a storage medium.

### Description of the Related Art

A recording medium (hereinafter, collectively referred to as a “sheet”) used for a printing operation is conveyed in a state of being charged with static electricity due to a residual charge generated in an electrophotographic process or due to slight friction with conveyance rollers or guides during the sheet conveyance. The static electricity may cause sheets to stick to each other. Further, dust or paper dust may attach to the printed product, leading to degradation in the product quality.

Plain paper or similar types of paper have low electric resistance in the sheet itself, allowing charge to move easily within the sheet. Thus, the amount of charge is small and the charge dissipates quickly. On the other hand, other types of sheets, such as thick paper, synthetic resin paper, and coated paper, in which a synthetic resin (plastic) is used, have high electrical resistance in the sheet itself, and thus charge does not easily move within the sheet. Consequently, these types of sheets, such as the synthetic paper and the coated paper, are easily charged, and the charge tends to remain. Further, it is generally known that these types of sheets, such as the synthetic resin paper and the coated paper, are susceptible to the environment, in particular, humidity, and are apt to be charged with static electricity because of a lower amount of discharge in environments with lower humidity.

If post-processing were performed on sheets sticking to each other, the sticking sheets would be likely to affect sheet alignment processing, not only degrading the quality of the post-processing, but causing a paper jam due to sheet feed failure or conveyance failure during the post-processing.

For that reason, in order to avoid the issue, it is desirable to remove static electricity from the sheets subjected to printing processing before the post-processing is performed.

Japanese Patent Laid-open No. 1999-258881 describes a technique of neutralizing electric charge on a sheet by applying a voltage to a pair of conveyance rollers disposed downstream in the sheet conveyance direction.

The charge removal method including applying a voltage to a pair of conveyance rollers (hereinafter, referred to as “charge removal rollers”) is of neutralizing charged static electricity by applying a charge with a polarity opposite to the electric charge on the sheets to the sheets via the charge removal rollers. The charge removal control using the charge removal rollers (the application of charge with the polarity opposite to that of the charge on the sheet to the charge removal rollers) needs to be performed based on the amount of charge on the sheet. This is because optimal charge values for static elimination exist for printing environments, such as temperature and humidity, and types of sheets. If a charge removal control were performed on a sheet under an inappropriate charge adjustment condition, the control would cause charging, leading more sheets to stick to each other. Thus, when printing is performed, for example, while switching between a plurality of types of sheets, it is necessary to perform a charge removal control suitable for each sheet type used in printing. Thus, there is also a technique of adding an application voltage value (hereinafter, referred to as “a charge removal setting value”) used for the charge removal control as an item in a database storing information about each sheet and of performing printing while performing the charge removal control on each sheet based on the charge removal setting value in printing.

In order to perform printing on various types of sheets while performing an appropriate charge removal control, it is necessary to register an optimal charge removal setting value for each sheet in information about the sheet. However, in order to obtain the optimal charge removal setting value for the sheet, a task is required that measures the amount of charge on a sheet subjected to printing.

Conventionally, in order to measure the amount of charge on a sheet, a special device referred to as a surface potential meter has been typically used for measuring the amount of charge on a surface of an object. Further, in order to accurately measure the amount of charge, it is also necessary to perform measurement with a charged sheet placed on a well-grounded metal plate or an electrically-conductive mat, which is a time-consuming and elaborate process. In this manner, the charge removal setting value is manually adjusted based on the amount of charge measured to perform the charge removal control in printing. However, the amount of charge on a sheet can seldom be reduced to an ideal level by a single adjustment.

Thus, in most cases, the procedure of the measurement and the adjustment is repeatedly performed until the amount of charge on the sheet reaches the ideal setting value. For this reason, the task of registering, in information about each sheet, an optimal charge removal setting value for the sheet entails a very time-consuming process.

### SUMMARY

According to an aspect of the present disclosure, a printing system includes a charge removal apparatus, a printer unit configured to print an image on a sheet, a measurement unit configured to measure an amount of charge on the sheet with the image printed thereon by the printer unit, a processor configured to calculate a charge removal setting value for charge removal using the charge removal apparatus based on the amount of charge measured by the measurement unit, and a storage device configured to store the charge removal setting value as information about the sheet.

Features of various embodiments will become apparent from the following description of embodiments with reference to the attached drawings. The following description of embodiments is described by way of example.

### BRIEF DESCRIPTION OF THE DRAWINGS

FIG. 1 illustrates a general configuration of a system according to a first embodiment.

FIG. 2 is a block diagram illustrating a hardware configuration of a printing device.

FIG. 3 is a cross-sectional diagram illustrating a hardware configuration of a printing system.

FIG. 4 illustrates an operation unit of a printing device.

FIG. 5 is a block diagram illustrating a hardware configuration of a charge removal apparatus.

FIG. 6 is a diagram illustrating an editing screen for parameters of a sheet and a setting screen for a charge removal setting value.

FIG. 7 is a schematic diagram for describing charge removal processing.

FIG. 8 is a flowchart illustrating processing for automatically setting a charge removal setting value according to the first embodiment.

FIGS. 9A to 9D illustrate display screens in the processing for automatically setting the charge removal setting value according to the first embodiment.

FIG. 10 illustrates a sheet feed source selection screen for a chart used for measuring the amount of charge for two-sided printing according to the first embodiment.

FIG. 11 is a flowchart illustrating measurement processing for the amount of charge on a sheet according to the first embodiment.

FIG. 12 is a flowchart illustrating processing for automatically setting a charge removal setting value according to a second embodiment.

FIG. 13 illustrates a device for measuring the amount of charge according to the second embodiment.

FIG. 14 illustrates charts used for measuring the amount of charge.

FIG. 15 illustrates a chart selection screen based on print coverage.

### DESCRIPTION OF THE EMBODIMENTS

### First Embodiment

A first embodiment to implement the present disclosure will now be described with reference to the attached drawings.

The following embodiments are not intended to limit the every embodiment or the scope of the claims, and not all the combinations of features described in the following embodiments are necessarily essential to the solutions provided by the disclosure.

### General Configuration of System

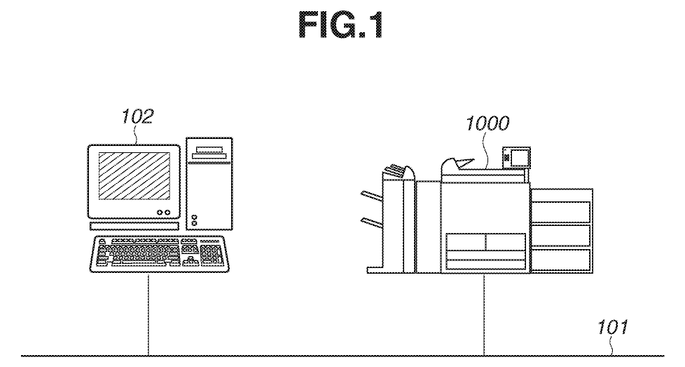

FIG. 1 illustrates a general system configuration in a most simplified form according to the present embodiment. The general system configuration includes a printing system 1000 and a client computer 102 (hereinafter, referred to as a “personal computer (PC) 102”), which are connected to each other via a network 101. The PC 102 can transmit page description language (PDL) code data as a print job to the printing system 1000 via the network 101.

### Hardware Configuration of Printing System

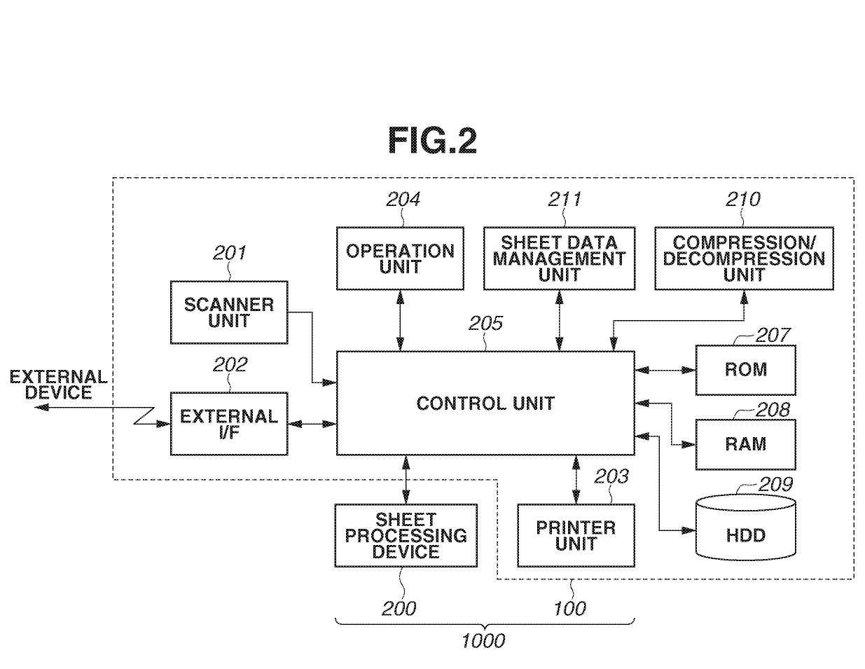

A hardware configuration of the printing system 1000 will now be described with reference to a system block diagram as illustrated in FIG. 2. The printing system 1000 includes a printing device 100, which is represented by a section enclosed by dotted lines in FIG. 2, and a sheet processing device 200. Further, any desired number of the sheet processing devices 200 can be connected to the printing device 100. In the present embodiment, an example will be described of, as the printing device 100, a multi-function peripheral (MFP) having a plurality of functions, such as a copy function and a printer function. However, the printing device 100 may be a single-function printing device having only a copy function or only a printer function. In the present embodiment, as an example, the printing system 1000 is assumed to include various components described in the following.

The printing system 1000 is configured to perform sheet processing on the sheets printed by the printing device 100 using the sheet processing device 200 connected to the printing device 100. However, the printing system 1000 can be configured only using the printing device 100 without connecting the sheet processing device 200 to the printing device 100. The sheet processing device 200 is configured to be communicable with the printing device 100, which allows the sheet processing device 200 to receive instructions from the printing device 100 to execute sheet processing described below.

A scanner unit 201 reads an image on a document, converts the read image into image data, and transmits the converted image data to another unit.

An external interface (I/F) 202 transmits data to and receives data from another device connected to the network 101.

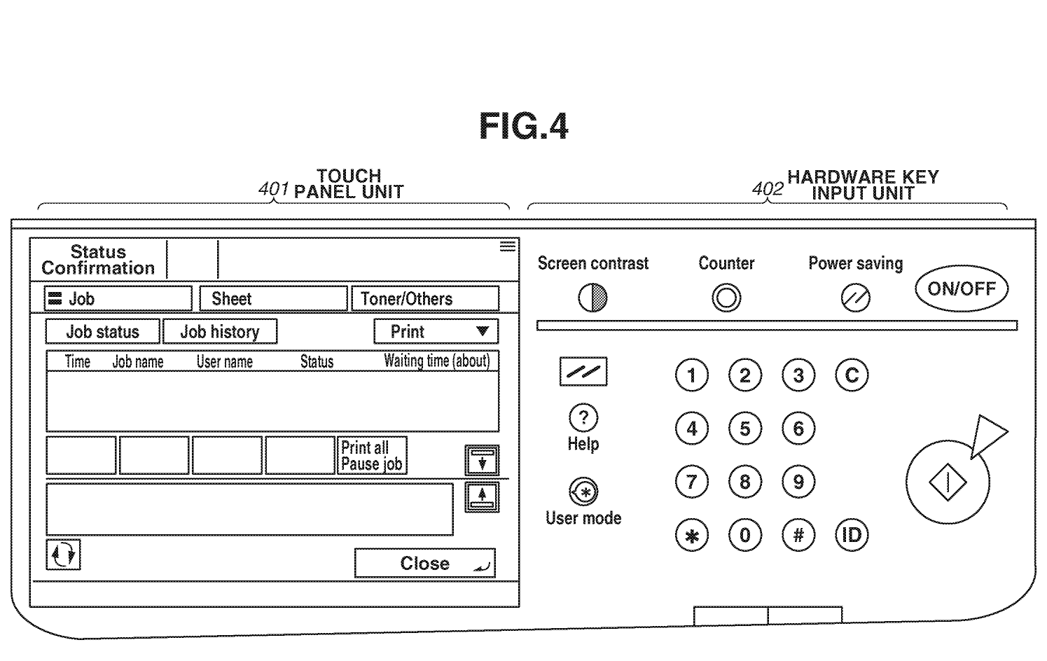

A printer unit 203 prints an image on a sheet based on the input image data. An operation unit 204 has a configuration illustrated in FIG. 4 and includes a hardware key input unit (a key input unit) 402 and a touch panel unit 401 as a display unit to receive instructions from a user through the key input unit 402 and the touch panel unit 401. Further, the operation unit 204 displays various types of screens on the touch panel unit 401 as the display unit included in the operation unit 204.

A control unit 205 generally controls the processing and the operation of each unit included in the printing system 1000. In other words, the control unit 205 controls the operation of the printing device 100 and the sheet processing device 200 connected to the printing device 100.

A read only memory (ROM) 207 stores various kinds of computer programs to be executed by the control unit 205.

For example, the ROM 207 stores programs for causing the control unit 205 to execute various kinds of processing of flowcharts described below or stores a display control program for displaying various setting screens described below. The ROM 207 stores a program for causing the control unit 205 to interpret the PDL code data received from the PC 102 to convert into raster image data. Further, the ROM 207 stores a boot sequence, font information, and the like.

A random access memory (RAM) 208 stores the image data and the PDL code data transmitted from the scanner unit 201 or the external I/F 202, various kinds of programs loaded from the ROM 207, and setting information. Further, the RAM 208 stores information regarding the sheet processing device 200 (for example, information regarding the type or the function of each of the sheet processing devices 200 connected to the printing device 100). The control unit 205 can use the information about the sheet processing devices 200 stored in the RAM 208 for control.

A hard disk drive (HDD) 209 includes a hard disk and a drive unit for reading data from and writing data to the hard disk. The HDD 209 is a large-capacity storage device for storing image data, which is input from the scanner unit 201, compressed by a compression and decompression unit 210.

The control unit 205 can cause the printer unit 203 to print the image data stored in the HDD 209 based on an instruction from the user. Further, the HDD 209 can be used as a spooler.

The control unit 205 manages the PDL code data received from the PC 102 as print jobs, and the control unit 205 can store the data in the HDD 209. Further, the control unit 205 can manage the print jobs stored in the HDD 209 and can obtain the number of print jobs stored and the setting information set for each of the print jobs.

The compression and decompression unit 210 compresses and decompresses the image data and the like stored in the RAM 208 and the HDD 209 using various types of compression methods, such as Joint Bi-level Image Experts Group (JBIG) and Joint Photographic Experts Group (JPEG).

A sheet data management unit 211 stores control parameters used at the time of sheet printing for each sheet type, and also for the product name of each sheet. Examples of the control parameters include characteristics of a sheet itself, such as a sheet grammage, a surface property, and a grain direction, a voltage setting value during a transfer, and a charge removal setting value during a charge removal control. Further, while the sheet data management unit 211 is illustrated in this manner as a part of the block diagram, the sheet data management unit 211 is actually a database, and the database itself is stored in the HDD 209.

### Sheet Parameter List Screen

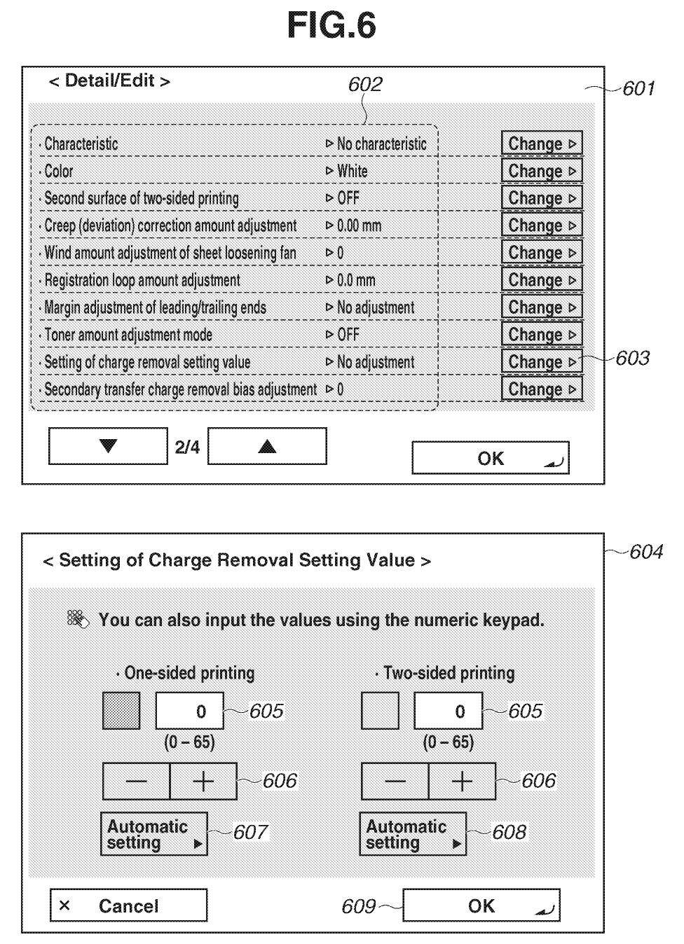

Further, the sheet data management unit 211 includes setting screens for referring to and editing content of the database, and FIG. 6 illustrates an example of the setting screens. The printing system 1000 is configured for the user to call a setting screen for each sheet via the operation unit 204. Then, upon receiving the call, the control unit 205 displays a sheet parameter list screen 601 on the touch panel unit 401 of the operation unit 204.

The sheet parameter list screen 601 includes parameters and a field 602 that displays the current setting values of the parameters, and each parameter is provided with a change button 603 to be pressed when the setting value is changed. For example, when the user presses the change button 603 to change the setting parameter of the charge removal setting value, the control unit 205 displays a setting screen 604 for the charge removal setting value on the touch panel unit 401 of the operation unit 204.

### Setting Screen for Charge Removal Setting Value

The setting screen 604 for the charge removal setting value includes display fields 605 for displaying current setting values and includes input buttons 606 for incrementing and decrementing the setting values. A setting for the sheet related to a charge removal application voltage value used in charge removal processing by a charge removal apparatus 200-3a described below can be configured via the setting screen 604 for the charge removal setting value. In the present embodiment, a charge removal setting value in this case is not set at an actual voltage value in kilovolts (kV) but at an intensity level within the range of 0 to 65. For the setting configured here, for example, the actual operation performs control through which a voltage of 0.1 (kV) is applied to a charge removal roller for each increment of +1. However, the unit of the setting value and the settable range described above are merely examples and are not limited thereto.

Further, in the present embodiment, a charge removal setting value used in one-sided printing and a charge removal setting value used in two-sided printing can be set separately. In a case where the one-sided printing is performed, processing for transfer to a sheet by a transfer drum 305 described below is performed once, while in a case where the two-sided printing is performed, additional transfer processing is performed on the surface opposite to the surface subjected to the printing. Thus, when the one-sided printing is performed, the amount of charge is different from when the two-sided printing is performed, even on the same sheet. As a result, this makes the charge removal setting value required to neutralize the amount of charge on the sheet during the charge removal processing also different, and thus, the charge removal setting value for the one-sided printing and the charge removal setting value for the two-sided printing can be set separately. Specifically, a display field 605 and an input button 606 are arranged in areas of the one-sided printing and the two-sided printing, respectively. Further, operations of automatic setting buttons 607 and 608 are described below, and description thereof will be omitted here.

Returning to the description, the control unit 205 is configured to access the database via the sheet data management unit 211 to acquire characteristic information about the sheet used in printing and parameter information used for the print control.

### Configuration of Printing System

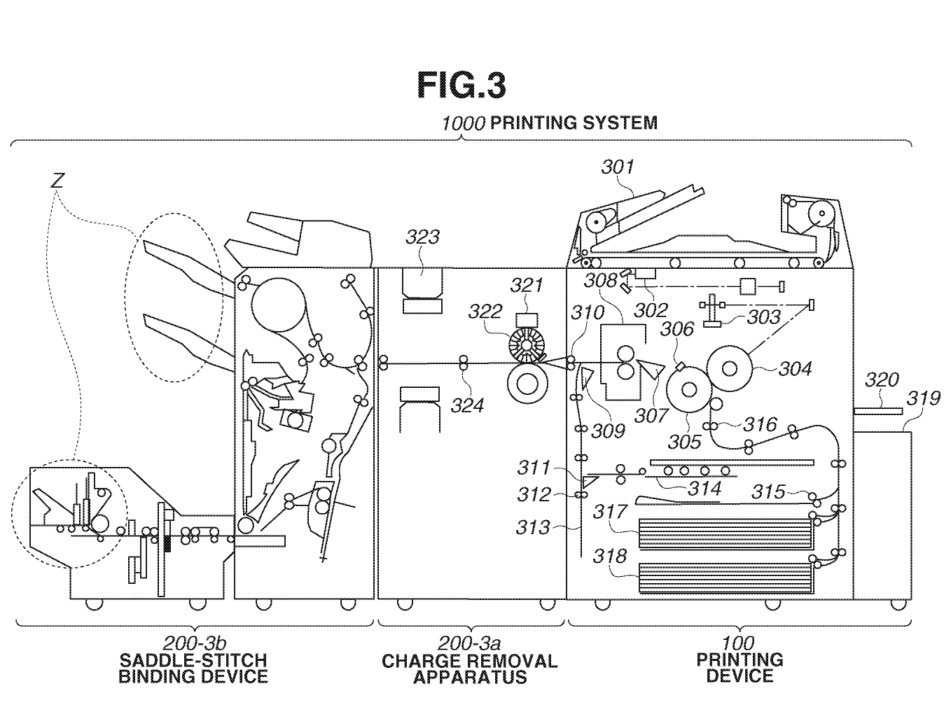

A configuration of the printing system 1000 will now be described with reference to FIG. 3. FIG. 3 is a cross-sectional diagram illustrating the printing device 100 and the sheet processing device 200 connected to the printing device 100. In FIG. 3, the sheet processing device 200 includes the charge removal apparatus 200-3a and a saddle-stitch binding device 200-3b.

### Printing Device

The printing device 100 will now be described. An automatic document feeder (ADF) 301 sequentially separates a bundle of sheets of a document placed on the document placement surface of a document tray from the first page in the page order to convey the sheets one by one onto a platen glass to be scanned by a scanner 302.

The scanner 302 reads images of the document conveyed onto the platen glass to convert the read images into image data by a charge-coupled device (CCD) sensor.

A rotating polygonal mirror 303 receives a light beam, for example, a laser beam modulated based on the image data to irradiate a photosensitive drum 304 with the laser beam as reflection scanning light via a reflection mirror.

A latent image formed on the photosensitive drum 304 by the laser beam is developed with toner, and the toner image is transferred to a sheet on a transfer drum 305. A series of image forming operations is performed for yellow (Y), magenta (M), cyan (C), and black (K) toners to form a full-color image.

After the four image processing operations, the sheet with the full-color image formed thereon on the transfer drum 305 is separated from the transfer drum 305 by a separation pawl 306 to be conveyed to a fixing device 308 by a pre-fixing conveyer 307.

The fixing device 308, provided with a combination of rollers and a belt, contains a heating source, such as a halogen heater, and melts to fix the toner as the transferred toner image on the sheet using heat and pressure.

A sheet ejection flapper 309, which is configured to be swingable around a swing shaft, controls the conveyance direction of the sheet. When the sheet ejection flapper 309 pivots in the clockwise direction in the drawing, the sheet is conveyed straight and discharged to the outside of the printing device 100 by sheet ejection rollers 310. The control unit 205 controls the printing device 100 to perform one-sided printing through the series of sequences described above.

### Two-Sided Printing

On the other hand, in a case where images are formed on both sides of the sheet, the sheet ejection flapper 309 pivots in the counterclockwise direction in the drawing, and the conveyance direction of the sheet is changed downward to convey the sheet to a two-sided conveyance unit.

The two-sided conveyance unit includes a reversing flapper 311, reversing rollers 312, a reversing guide 313, and a two-sided tray 314.

The reversing flapper 311 swings around a swing shaft to control the conveyance direction of the sheet. In a case where a two-sided print job is processed, the control unit 205 controls the reversing flapper 311 to pivot in the counterclockwise direction in the drawing to convey the sheet with a first surface subjected to printing by the printer unit 203 to the reversing guide 313 via the reversing rollers 312.

Then, the control unit 205 once stops the reversing rollers 312 with the trailing edge of the sheet nipped between the reversing rollers 312, and then the control unit 205 pivots the reversing flapper 311 in the clockwise direction in the drawing. In addition, the control unit 205 rotates the reversing rollers 312 in the opposite direction. Through this operation, the control unit 205 controls the sheet to be conveyed in a switchback manner to be guided to the two-sided tray 314 with the trailing and leading edges of the sheet switched.

The sheet is once placed on the two-sided tray 314, and then the sheet is conveyed to a registration roller 316 again by a sheet re-feed roller 315. In this case, the sheet is being conveyed with the surface (a second sheet surface) opposite to the first surface subjected to the transfer processing facing the photosensitive drum 304. Then, as in the process described above, an image for the second sheet surface is formed on the second sheet surface. The images are formed on both the surfaces of the sheet, and the sheet goes through the fixing processing and then is discharged to the outside of the main body of the printing device 100 via the sheet ejection rollers 310. The control unit 205 controls the printing device 100 to perform the two-sided printing through the series of sequences described above.

Further, the printing device 100 includes sheet feed units that store sheets for printing processing. The sheet feed units are sheet feed cassettes 317 and 318 (e.g., each of the cassettes has a capacity of 500 sheets), a sheet feed deck 319 (e.g., the deck has a capacity of 5,000 sheets), a manual sheet feed tray 320, and another similar type of unit. Sheets of various sizes and materials can be loaded in the sheet feed cassettes 317 and 318 and in the sheet feed deck 319 separately for each sheet feed unit. Further, various types of sheets including special sheets, such as synthetic paper and films, can be placed on the manual sheet feed tray 320.

### Charge Removal Apparatus

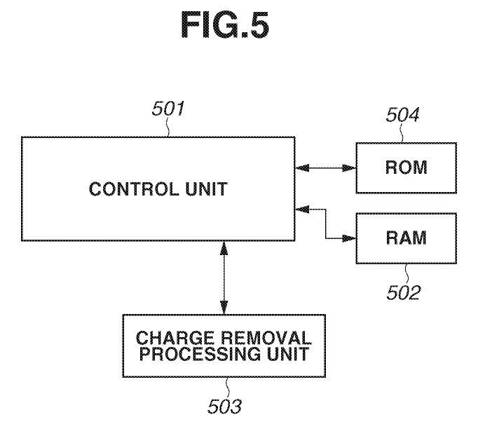

The charge removal apparatus 200-3a will now be described. FIG. 5 is a block diagram illustrating a hardware configuration of the charge removal apparatus 200-3a. The charge removal apparatus 200-3a also includes a control unit 501 separate from the printing device 100, and the control unit 501 is configured to generally control the entire charge removal apparatus 200-3a while communicating with the control unit 205 of the printing device 100 in FIG. 2 via a non-illustrated bus.

A charge removal processing unit 503, which includes a voltage application controller 321 for both a charge removal roller 322 and an ionizer 323 described below, is configured to perform charge removal processing on a conveyed sheet. The control unit 501 performs control to apply voltages to the charge removal roller 322 and the ionizer 323 via the voltage application controller 321.

A ROM 504 stores a boot program for the charge removal apparatus 200-3a, a charge removal processing program for the charge removal processing unit 503, and the like. The control unit 501 then loads a required program as appropriate from the ROM 504 into a RAM 502 to execute the loaded program.

### Charge Removal Processing

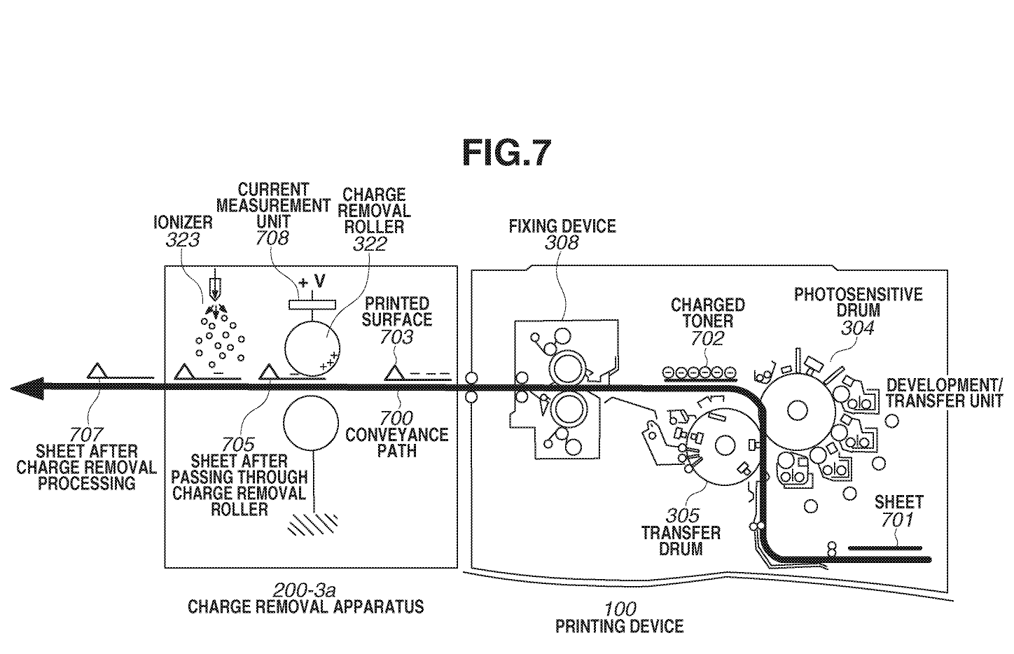

The charge removal processing performed by the charge removal processing unit 503 will now be described with reference to FIG. 7. FIG. 7 is a schematic diagram illustrating a state where the charge removal processing is performed by the charge removal apparatus 200-3a on the sheet subjected to the printing processing performed by the printing device 100. Components common to those in FIG. 3 are denoted by the same numbers.

First, a sheet 701 is conveyed via a conveyance path 700 to a development and transfer section that contains the photosensitive drum 304 and the transfer drum 305, and a toner image is transferred to the sheet 701. Charged toner 702 on the sheet 701 is negatively charged, and the sheet with the toner fixed thereto by the fixing device 308 is conveyed to the charge removal apparatus 200-3a in a state where the toner on a printed surface 703 of the sheet 701 is negatively charged.

The charge removal apparatus 200-3a includes the charge removal roller 322 that is being positively charged, and the charge removal roller 322 applies positive charge to the negatively charged printed surface 703 in contact with the charge removal roller 322 to neutralize the charged state. However, it is conceivable that either negative charge, that has not been completely removed through the charge removal processing using the charge removal roller 322, or conversely, positive charge would remain on a sheet 705 that has passed through the charge removal roller 322.

Thus, the charge removal apparatus 200-3a described in the present embodiment is configured to further include the ionizer 323 downstream of the charge removal roller 322. The ionizer 323 applies a voltage to an electrode needle included in the ionizer 323 to generate corona discharge to remove charge using ions generated by the corona discharge. In this manner, by the charge removal roller 322 performing rough charge removal and the ionizer 323 adjusting the residual charge, a sheet 707 subjected to the charge removal processing ejected from the charge removal apparatus 200-3a is in a state where the charge is neutralized. Further, in the charge removal apparatus 200-3a, a current measurement unit 708 is configured to measure a current value that flows while the sheet is being nipped by the charge removal roller 322 and the paired roller.

Returning to the description with reference to the cross-sectional diagram in FIG. 3, the charge removal apparatus 200-3a includes the charge removal roller 322 and the paired roller. The sheet conveyed to the charge removal apparatus 200-3a is conveyed while being nipped by the charge removal roller 322 and the paired roller to be subjected to the rough charge removal by the charge removal roller 322 described above. The ionizer 323 then performs the charge removal processing on the residual charge while the sheet is being conveyed to the outside of the charge removal apparatus 200-3a by a conveyance roller 324.

### Saddle-Stitch Binding Device

The saddle-stitch binding device 200-3b will now be described. Examples of the sheet processing by the saddle-stitch binding device 200-3b include saddle-stitch binding, punching processing, cutting processing, shift sheet ejection processing, folding processing, and stapling processing. In the present embodiment, these jobs are collectively referred to as a "saddle-stitch binding job".

In a case where a saddle-stitch binding job is processed, first, the control unit 205 causes the charge removal apparatus 200-3a to convey a sheet for this job printed by the printing device 100 to the saddle-stitch binding device 200-3b, and then the control unit 205 causes the saddle-stitch binding device 200-3b to perform the sheet processing for the job. Then, the control unit 205 causes the corresponding sheet ejection destination portion Z of the saddle-stitch binding device 200-3b to hold the printed product of the saddle-stitch binding job, which is subjected to the sheet processing performed by the saddle-stitch binding device 200-3b. In addition, as a sheet ejection destination Z, there is a plurality of sheet ejection destination candidates. This is why the saddle-stitch binding device 200-3b can perform a plurality of types of sheet processing, and each of the sheet ejection destination portions is used when sheets are each sorted to the corresponding sheet ejection destination portion every time the sheet processing is performed. In the present embodiment, a detailed conveyance procedure of the saddle-stitch binding job will be omitted.

### Processing for Automatically Setting Charge Removal Setting Value

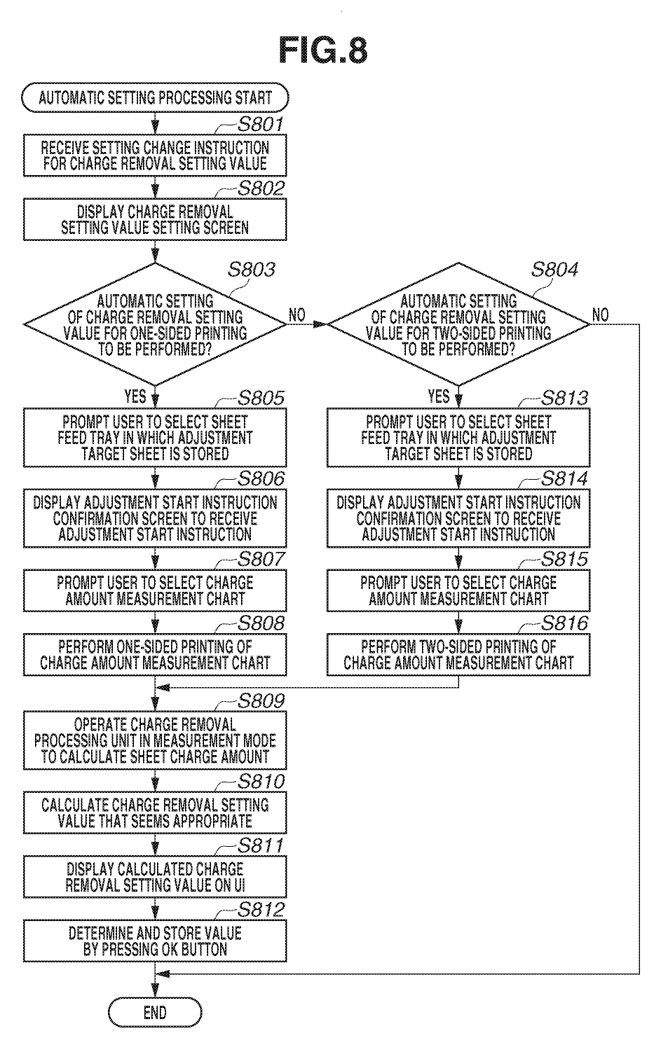

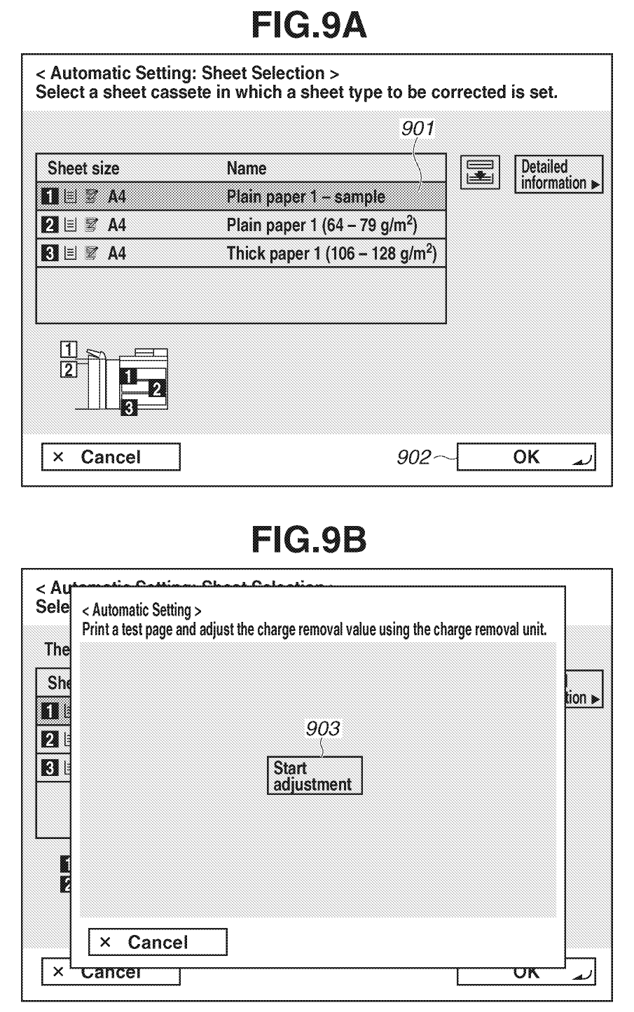

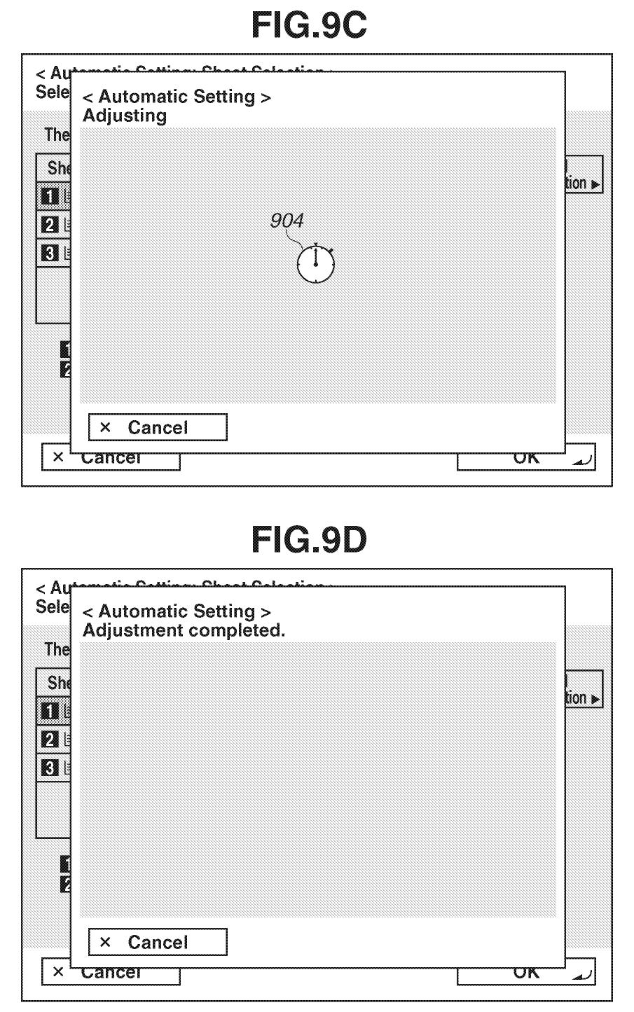

Processing for automatically setting a charge removal setting value according to the present embodiment will now be described with reference to a flowchart in FIG. 8 and to screens displayed at the time of the automatic setting processing in FIGS. 9A and 9B. This processing is performed by the control unit 205 of the printing device 100 that operates in coordination with the control unit 501 of the charge removal apparatus 200-3a loading a program stored in the ROM 207 into the RAM 208 to execute the loaded program.

In step S801, the control unit 205 receives an instruction to change the setting of a parameter upon the user pressing the change button 603 for setting the charge removal setting value on the sheet parameter list screen 601 in FIG. 6 described above.

In step S802, the control unit 205 displays the setting screen 604 for the charge removal setting value.

In step S803, the control unit 205 determines whether an instruction to automatically set the charge removal setting value used in the one-sided printing has been issued by the user pressing the automatic setting button 607 for a setting value for the one-sided printing, which is included in the setting screen 604 for the charge removal setting value. In step S803, if the instruction has been issued (YES in step S803), the processing proceeds to step S805.

### When Automatic Setting is Performed for Charge Removal Setting Value in One-Sided Printing

In step S805, a screen as illustrated in FIG. 9A is displayed by the control unit 205 to prompt the user to select a sheet feed tray in which an adjustment target sheet is loaded. Then, in step S805, upon the user selecting a tray from a candidate sheet feed tray list 901 and pressing an OK button 902, a check screen is displayed by the control unit 205 for an adjustment start instruction in FIG. 9B.

In step S806, the control unit 205 receives an adjustment start instruction by the user pressing an adjustment start button 903 on the check screen illustrated in FIG. 9B for the adjustment start instruction.

In addition, upon receiving the adjustment start instruction, the control unit 205 transitions the screen to an adjustment-in-progress screen as illustrated in FIG. 9C. The control unit 205 performs control to issue a notification to the user that the adjustment is being performed (i.e., the adjustment operation is in progress) using an icon, such as a clock mark 904, indicating that the adjustment operation is ongoing.

In step S807, the control unit 205 prompts the user to select a chart to be used for measuring the amount of charge on the target sheet in the one-sided printing.

### Chart for Measuring the Amount of Charge

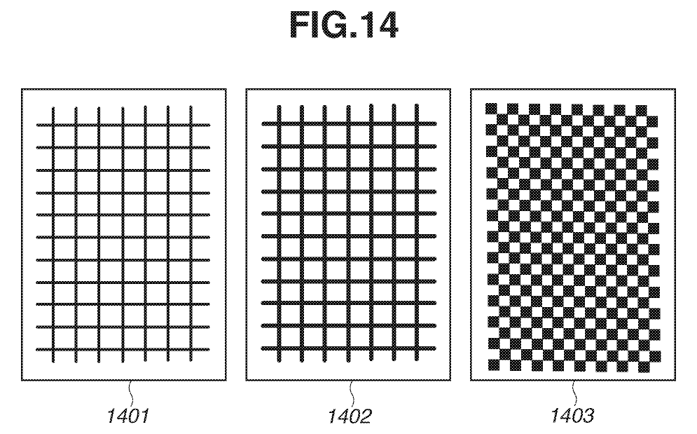

In this case, in the present embodiment, in step S807, the control unit 205 prompts the user to select a chart from among three types of amount-of-charge measurement charts exemplified in FIG. 14. In FIG. 14, three types of charts, which include a thin-line grid chart 1401, a thick-line grid chart 1402 with lines thicker than that of the thin-line grid chart 1401, and a checkered pattern chart 1403, are provided. These are the charts designed so that print coverage (printing duty ratio), which refers to the proportion of the printed area relative to the entire area of the sheet, increases in this order, and the checkered pattern chart 1403 has the highest print coverage. In general, based on the fact that the amount of charge on a sheet tends to increase as the print coverage increases, the user selects a chart having a print coverage closest to that of an actual document to be printed.

### Chart Selection Screen

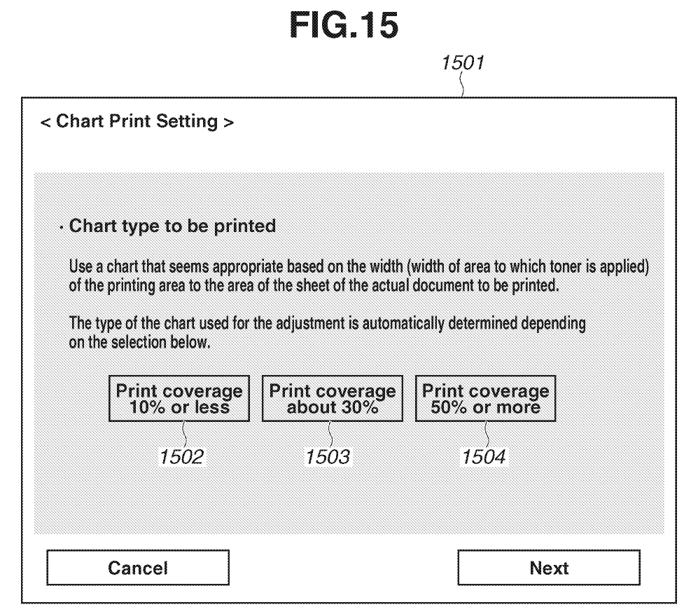

Thus, a chart selection screen is displayed by the control unit 205 as exemplified in FIG. 15 to prompt the user to select a print coverage of the document. Then, the control unit 205 determines a chart used in the adjustment based on the selected print coverage.

When a "print coverage 10% or less" button 1502 is selected, the control unit 205 determines that the thin-line grid chart 1401 is selected, and when a "print coverage about 30%" button 1503 is selected, the control unit 205 determines that the thick-line grid chart 1402 is selected. Further, when a "print coverage about 50%" button 1504 is selected, the control unit 205 determines that the checkered pattern chart 1403 is selected. Through the above-described processing, the control unit 205 determines the chart to be used in measuring the amount of charge. Further, a blank sheet may be used as a chart without using the charts described above. In this case, the print coverage of the document is not taken into consideration, resulting in reduced accuracy of the charge removal processing itself. However, the complexity of the operation and the processing is decreased.

Returning to the flowchart in FIG. 8, the description continues.

In step S808, the selected chart to be used for measuring the amount of charge is printed on one side of a sheet, and the processing proceeds to step S809.

On the other hand, in step S803, if the instruction has not been issued (NO in step S803), the processing proceeds to step S804. In step S804, the control unit 205 determines whether an instruction to automatically set a charge removal setting value used in two-sided printing is issued by pressing the automatic setting button 608 for two-sided printing. In step S804, if the automatic setting instruction is issued (YES in step S804), the processing proceeds to step S813. If the automatic setting instruction is not issued (NO in step S804), the control unit 205 ends the present processing without performing processing related to the automatic setting.

### When Charge Removal Setting Value in Two-Sided Printing is Set Automatically

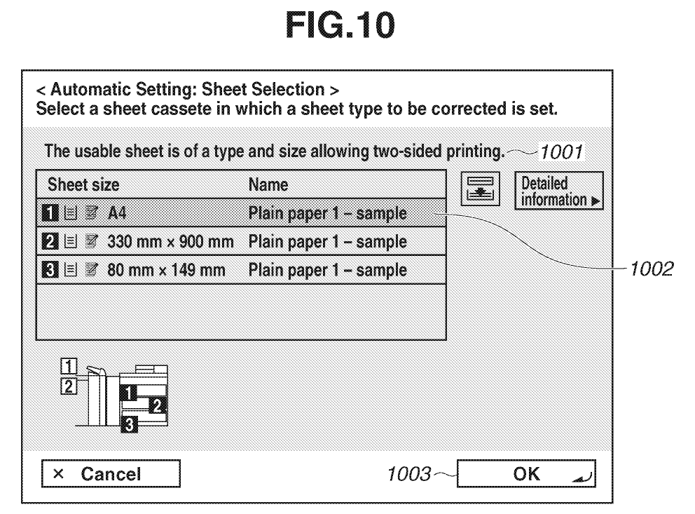

In step S813, the control unit 205 causes the display unit to display a screen, illustrated in FIG. 10, that is used to select a sheet feed source for a chart to be used for measuring the amount of charge in two-sided printing to prompt the user to select a sheet feed tray in which an adjustment target sheet is loaded.

In this case, when the adjustment in two-sided printing is performed, it is necessary to prompt the user to select a sheet printable on both sides. Thus, a caution message 1001 as illustrated in FIG. 10 is displayed on the screen. Further, in a sheet feed source candidate tray list 1002, any sheet feed tray in which sheets that cannot be used for two-sided printing are loaded is grayed out to be controlled not to be selectable. The screen example illustrates a case where two-sided printing cannot be performed by the target printing device because the sheet size is too large or too small. In step S813, if the user selects a tray, and then presses an "OK" button 1003, similarly to the adjustment in one-sided printing, the adjustment start instruction check screen illustrated in FIG. 9B is displayed.

In step S814, the control unit 205 receives the adjustment start instruction by the user pressing the adjustment start button 903. Also in this case, similarly in step S806, the adjusting screen illustrated in FIG. 9C is displayed.

In step S815, the control unit 205 prompts the user to select a chart to be used for measuring the amount of charge on the target sheet in two-sided printing. The processing performed in step S815 is similar to that performed in step S807 in the flowchart for the measurement in one-sided printing, and thus the description will be omitted. Further, as for selection of the chart, the print coverages of the front and the back of a sheet may be checked so that different charts are used for the front and the back of the sheet.

In step S816, the chart used in measuring the amount of charge is printed on both sides of the sheet.

Processing after the measurement chart is printed in step S808 or step S815 will now be described.

In step S809, via the control unit 501 of the charge removal apparatus 200-3a, the control unit 205 causes the charge removal processing unit 503 to operate in not a charge removal mode but in a measurement mode to measure the amount of charge on the conveyed sheet with the chart for measuring the amount of charge printed thereon.

### Amount of Charge Calculation Processing

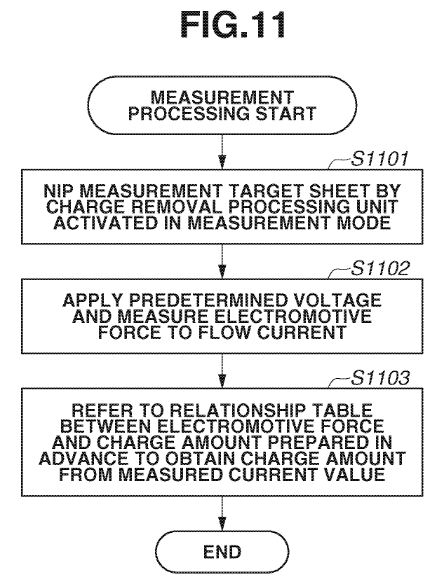

The measurement processing in step S809 will additionally be described with reference to a flowchart in FIG. 11.

First, as described above, the charge removal processing unit 503 normally applies a voltage based on the set charge removal setting value to perform the charge removal processing on the sheet using the applied voltage. However, in addition to this operation, the charge removal processing unit 503 is configured to cause the current measurement unit 708 to measure a current value corresponding to the electric current flowing while the sheet is being nipped with a predetermined constant voltage being applied thereto. This operation mode is referred to as the "measurement mode" in the present embodiment. In general, when two voltages with a difference therebetween are applied to an object, a force, referred to as an electromotive force, is generated, and the force makes an electric current flow between the two points, causing the electric current to flow.

The amount of electric current that flows depends on the difference in applied voltage. Thus, it is possible to calculate a voltage difference backward from the amount of electric current that flows by measuring in advance the voltage difference and the amount of electric current that flows with each sheet.

In the measurement processing in step S809, the control unit 205 and the control unit 501 of the charge removal apparatus 200-3a operate in coordination with each other to measure the amount of charge on the sheet using the above-described method.

In step S1101, the control unit 205 causes the charge removal processing unit 503 to operate in the measurement mode via the control unit 501 of the charge removal apparatus 200-3a, and then the conveyed sheet is nipped between the charge removal roller 322 and its paired roller.

In step S1102, the control unit 501 of the charge removal apparatus 200-3a applies a predetermined constant voltage to the charge removal roller 322 to measure the amount of the electric current that flows at that time using the current measurement unit 708.

In step S1103, the control unit 501 of the charge removal apparatus 200-3a refers to a relationship table regarding the amounts of electric currents and the voltage differences created in advance and stored in the ROM 504 of the charge removal apparatus 200-3a to calculate the voltage difference and the amount of charge on the sheet from the amount of the electric current measured by the current measurement unit 708. In this manner, the amount of charge on the conveyed sheet with the chart for measuring the amount of charge printed thereon is obtained.

Returning to the flowchart in FIG. 8, the description continues.

In step S810, the control unit 205 calculates the charge removal setting value considered to be necessary for the charge removal from the amount of charge on the sheet calculated in step S809 as described above. In the present embodiment, the charge removal setting value is calculated so that the amount of charge on the sheet is controlled to be neutralized by applying the inverse value of the amount of charge calculated in step S809. In response to completion of the calculation of the charge removal setting value, the control unit 205 switches the screen to a screen in FIG. 9D to inform the user that the adjustment processing for the automatic setting is completed.

In step S811, the control unit 205 automatically switches the screen to the setting screen 604 for the charge removal setting value in FIG. 6, and the control unit 205 displays the charge removal setting value calculated in step S810 in a manner that updates the value in the display field 605.

Further, when the automatic setting of the setting value in the one-sided printing is performed, the charge removal setting value in the one-sided printing is displayed in the display field 605 for the one-sided printing, and when the automatic setting of the setting value in the two-sided printing is performed, the charge removal setting value in the two-sided printing is displayed in the display field 605 for the two-sided printing. Further, for the value displayed in each of the display fields 605 in FIG. 6, the user can perform fine adjustment using the corresponding input button 606 used to input an increment or a decrement disposed below the corresponding display field 605.

In step S812, the setting value through the fine adjustment performed by the user is determined, and pressing of an "OK" button 609 on the setting screen 604 for the charge removal setting value is detected. The control unit 205 controls, via the sheet data management unit 211, the value of a charge removal setting value item in the sheet parameter information about the target sheet to be updated, stored, and managed.

In the present embodiment, the charge removal setting value calculated in step S810 is displayed in the corresponding display field 605 in FIG. 6, and the content is stored by pressing the "OK" button 609 on the setting screen 604 for the charge removal setting value. However, the storage processing may be performed together with the calculation of the charge removal setting value. In this case, after the charge removal setting value is calculated in step S810, the control unit 205 skips the processing in steps S811 and S812, and the control unit 205 stores the calculated value in the sheet parameter information. The control unit 205 then switches the screen to a screen in FIG. 9D. After the user is notified that the adjustment processing of the automatic setting has been completed, the screen is controlled to be automatically switched to the sheet parameter list screen 601 in FIG. 6.

The control in this manner allows the automatic setting for the charge removal setting value, shortening the time-consuming process taken to determine the optimal charge removal setting value.

### Second Embodiment

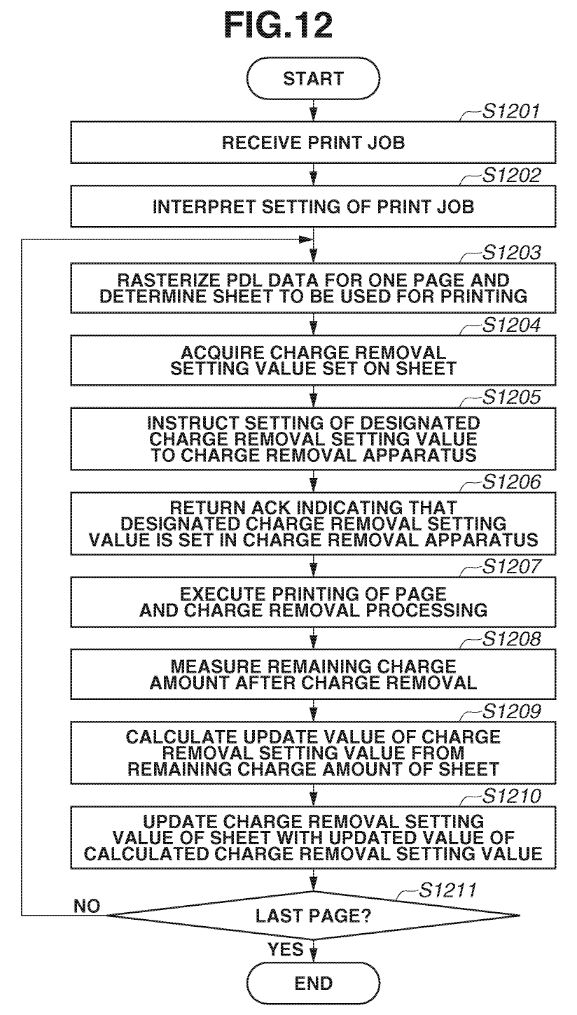

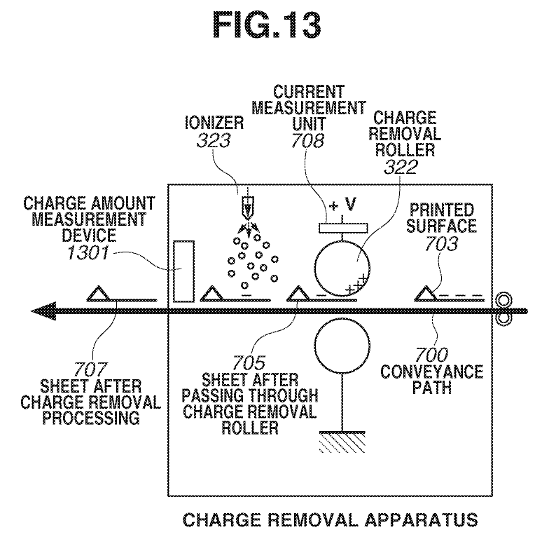

In the first embodiment, the method is described of measuring an amount of charge on a sheet output without performing the charge removal processing, setting a charge removal setting value that is recommended from the amount of charge measured, and storing and updating the recommended charge removal setting value as a piece of the sheet information (the sheet parameters) about a target sheet. In a second embodiment, a method will be described of measuring an amount of charge (the amount of residual charge) on a sheet subjected to the charge removal processing, setting a charge removal setting value that is recommended from the amount of charge measured, and storing and updating the recommended charge removal setting value as a piece of sheet information (sheet parameters) of a target sheet with reference to FIGS. 12 and 13.

First, processing will be described of measuring an amount of residual charge on a sheet subjected to the charge removal processing to calculate and store a charge removal setting value from the amount of residual charge measured, with reference to a flowchart in FIG. 12. This processing is performed by the control unit 205 of the printing device 100 that operates in coordination with the control unit 501 of the charge removal apparatus 200-3a loading a program stored in the ROM 207 into the RAM 208 to execute the loaded program.

In step S1201, the control unit 205 of the printing device 100 receives a print job via the network 101 and the external I/F 202.

In step S1202, the control unit 205 interprets the setting of the print job received in step S1201 to determine specified details, such as the number of copies, a sheet ejection destination, and post-processing.

In step S1203, the control unit 205 reads page description language (PDL) data for one page from a spooler, rasterizes the PDL data, and determines the type of sheet to be used to print the page.

In step S1204, the control unit 205 obtains, via the sheet data management unit 211, the setting of the charge removal setting value set for the sheet type determined in step S1203.

In step S1205, the control unit 205 notifies the control unit 501 of the charge removal apparatus 200-3a of the setting of the charge removal setting value obtained in step S1204 to issue an instruction about the voltage application setting to the charge removal roller 322.

In step S1206, the control unit 501 of the charge removal apparatus 200-3a actually causes the voltage application controller 321 to apply the voltage of the charge removal setting value to the charge removal roller 322 using the setting of the charge removal setting value received in step S1205. Further, the control unit 501 receives the setting of the charge removal setting value to notify the control unit 205 of the printing device 100 that the voltage application of the charge removal setting value has been executed (acknowledgement (ACK)).

In step S1207, upon receiving the notification of executing the voltage application of the charge removal setting value from the control unit 501 of the charge removal apparatus 200-3a in step S1206, the control unit 205 of the printing device 100 controls the page to be printed via the printer unit 203.

Further, the control unit 205 executes the charge removal processing on the printed sheet via the control unit 501 of the charge removal apparatus 200-3a.

In step S1208, the control unit 205 measures via the control unit 501 of the charge removal apparatus 200-3a the amount of residual charge on the sheet subjected to the charge removal processing in step S1207. In this case, in the present embodiment, as illustrated in FIG. 13, in order to enable the measurement in step S1208, the amount of charge measurement device 1301 is disposed immediately before the exit of the charge removal apparatus 200-3a for measuring the amount of residual charge on the sheet subjected to the charge removal processing.

FIG. 13 illustrates the charge removal apparatus 200-3a alone from FIG. 7, and components other than the added charge amount measurement device 1301 are the same as those in FIG. 7. Further, in the charge amount measurement device 1301, a known technique, for example, described in Japanese Patent Laid-open No. 1993-172886, is used, and a detailed description thereof will be omitted.

In step S1209, the control unit 205 again calculates the recommended value of a corrected charge removal setting value from the amount of residual charge on the sheet measured in step S1208. Further, in the present embodiment, with focus on the difference in the amount of residual charge from the previous page, if the difference tends to increase in the positive direction, the charge removal setting value is finalized to increase in the negative direction. Conversely, if the difference tends to increase in the negative direction, the charge removal setting value is finalized to increase in the positive direction so as to change the amount of residual charge. Then, the control unit 205 calculates the update value of the charge removal setting value so as to determine the value that is to be linearly increased or decreased depending on the absolute value of the difference.

In step S1210, the control unit 205 performs processing to update the charge removal setting value of the sheet with the update value of the charge removal setting value calculated in step S1209 to control the next page to be printed using the updated charge removal setting value.

In step S1211, finally, the control unit 205 determines whether the printed sheet is the last page.

If the control unit 205 determines that the printed sheet is the last page (YES in step S1211), the processing ends. On the other hand, if the control unit 205 determines that the printed sheet is not the last page (NO in step S1211), the processing returns to step S1203 to perform the processing again on the next page.

By performing such control on all the pages included in a print job, even in a print job including a plurality of types of sheets, the charge removal control can be performed based on the type of the sheet while the charge removal setting value is updated to a recommended value for each sheet during printing.

Further, the method of updating a charge removal setting value by measuring an amount of residual charge on a sheet subjected to the charge removal processing during printing according to the present embodiment may be combined with the method of setting a charge removal setting value for a sheet by printing a chart used for measuring an amount of charge according to the first embodiment.

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-020586, which was filed on February 12, 2025 and which is hereby incorporated by reference herein in its entirety.

What is claimed is:

1. A printing system including a charge removal apparatus, the printing system comprising:
a printer unit configured to print an image on a sheet;
a measurement unit configured to measure an amount of charge on the sheet with the image printed thereon by the printer unit;
a processor configured to calculate a charge removal setting value for charge removal using the charge removal apparatus based on the amount of charge measured by the measurement unit; and
a storage device configured to store the charge removal setting value as information about the sheet.

2. The printing system according to claim 1, further comprising a display configured to display a screen to set the charge removal setting value,
wherein the storage device stores the charge removal setting value upon receiving an automatic setting instruction for the charge removal setting value via the screen.

3. The printing system according to claim 2, wherein the screen includes a control configured to select a sheet feed unit for a sheet on which a chart used to measure the amount of charge is to be printed.

4. The printing system according to claim 3, wherein the control is configured to select a sheet feed unit alone in which a sheet available for two-sided printing is placed as the sheet feed unit for the sheet for printing the chart used to measure the amount of charge in a case where the charge removal setting value for the two-sided printing is set.

5. The printing system according to claim 2, wherein the screen includes control configured to adjust the charge removal setting value calculated by the processor.

6. The printing system according to claim 2, wherein the display displays on the screen a control configured to allow a user to designate a chart used to measure the amount of charge.

7. The printing system according to claim 6, wherein by selecting a print coverage, a chart corresponding to the print coverage is selected as the chart used to measure the amount of charge.

8. The printing system according to claim 1, wherein the storage device stores a first charge removal setting value for one-sided printing for the sheet and stores a second charge removal setting value for two-sided printing for the sheet as the information about the sheet.

9. The printing system according to claim 1, wherein the measurement unit measures the amount of charge on the sheet with a chart used to measure the amount of charge printed thereon by the printer unit.

10. The printing system according to claim 1, wherein the measurement unit is an electric current measurement unit connected to a charge removal roller of the charge removal apparatus.

11. The printing system according to claim 1,
wherein the charge removal apparatus includes a different measurement unit configured to measure an amount of residual charge on the sheet subjected to the charge removal, and
wherein the storage device stores another charge removal setting value calculated based on the amount of residual charge measured by the different measurement unit.

12. A control method for a printing system including a charge removal apparatus, the control method comprising:
printing an image on a sheet;
measuring an amount of charge on the sheet with the image printed thereon in the printing;
calculating a charge removal setting value for charge removal using the charge removal apparatus based on the amount of charge on the sheet; and
storing the calculated charge removal setting value as information about the sheet.

13. A non-transitory computer readable storage medium storing computer-executable instructions for causing a computer to execute a control method for a printing system including a charge removal apparatus, the control method comprising:
printing an image on a sheet;
measuring an amount of charge on the sheet with the image printed thereon in the printing;
calculating a charge removal setting value for charge removal using the charge removal apparatus based on the amount of charge on the sheet; and
storing the calculated charge removal setting value as information about the sheet.
